(19) United States
(12) Patent Application Publication
(10) Pub. No.: US 2014/0240489 A1
(43) Pub. Date: Aug. 28, 2014

(54) OPTICAL INSPECTION SYSTEMS AND METHODS FOR DETECTING SURFACE DISCONTINUITY DEFECTS

(71) Applicant: Corning Incorporated, Corning, NY (US)

(72) Inventor: William John Furnas, Elmira, NY (US)

(73) Assignee: Corning Incorporated, Corning, NY (US)

(21) Appl. No.: 13/777,692

(22) Filed: Feb. 26, 2013

(51) Int. Cl. G01N 21/88

(52) U.S. Cl. CPC G01N 21/8806
USPC 348/131

(57) ABSTRACT

Optical inspection system and methods for detecting surface discontinuity defects in glass sheet are disclosed. A reflective diffuser resides adjacent a back surface of the glass sheet and is illuminated with gradient intensity illumination. A digital camera having a two-dimensional image sensor resides adjacent the front surface of the glass sheet. The digital camera has, at the reflective diffuser, an acceptance circle that shifts relative to the gradient illumination due to the surface discontinuity. The shift causes the digital inspection image to change intensity, and the change is faster than if the illumination of the reflective diffuser had uniform intensity.

### FIELD

The present disclosure relates to the optical inspection systems and methods, and in particular relates to optical inspection systems and methods that utilize an area array for detecting surface discontinuity defects.

### BACKGROUND

Optical display glass is formed in large sheets on a glass manufacturing line. The display glass needs to be inspected for defects or manufacturing anomalies prior to being further processed and included in any one of a variety of display devices. The inspection is typically optically based and usually performed in two steps: a coarse optical inspection that covers the entire glass sheet to identify locations that need to be revisited for closer inspection, and a revisit optical inspection that takes a closer look at the locations identified in the course inspection.

The revisit inspection is performed using an optical inspection system. The optical inspection system acquires multiple images of the problematic location on the glass sheet. The multiple images are taken under different illumination conditions and at different locations at the surfaces and within the glass sheet so that the potential defect or anomaly can be more easily detected, located and characterized.

Detection of surface discontinuity (SD) defects with an area-array camera system (i.e., a camera system with a two-dimensional image sensor) to date has proven problematic because it is difficult obtain uniform detection across the field of view. Thus, SD defects are usually detected with line scan cameras wherein a slit detector is used with a knife-edge light source. However, it would be advantageous to be able to use an area-array camera to simplify the system and perform faster inspections for SD defects.

### SUMMARY

An aspect of the disclosure is an optical inspection system for detecting a surface discontinuity defect in a glass sheet having front and back surfaces. The system includes a digital camera arranged adjacent the front surface of the glass sheet and along a system axis. The digital camera has a two-dimensional image sensor (i.e., area array detector) that captures a digital inspection image of an inspection region of the glass sheet. The system also includes a reflective diffuser arranged along the system axis adjacent and spaced apart from the back side of the glass sheet. The digital camera has an acceptance circle at the reflective diffuser. The system further includes a gradient illumination source arranged to provide gradient illumination light through the glass sheet from the front side to form a gradient illumination region on the reflective diffuser. The acceptance circle of the digital camera partially overlaps the gradient illumination region and can shift relative to the gradient illumination region due to the presence of the surface discontinuity defect within the inspection region.

Another aspect of the disclosure is the optical inspection system as described above, wherein the acceptance circle partial overlap occurs at an edge of the gradient illumination region, and wherein the gradient illumination region is darkest at the edge.

Another aspect of the disclosure is the optical inspection system as described above, wherein the gradient illumination region has a sub-region of constant intensity that resides adjacent the edge.

Another aspect of the disclosure is the optical inspection system as described above, wherein the constant-intensity sub-region and the acceptance circle have substantially the same dimension in the direction of shift in the acceptance circle.

Another aspect of the disclosure is the optical inspection system as described above, wherein the gradient illumination region has a linear intensity variation in a direction of the shift in the acceptance circle as caused by the surface continuity defect.

Another aspect of the disclosure is a method of optically inspecting a glass sheet having front and back surfaces for a surface discontinuity defect. The method includes illuminating a reflective diffuser arranged adjacent and spaced apart from the back side of glass sheet. The illumination travels through the glass sheet and forms an illumination region on the reflective diffuser, wherein the illumination region has a gradient intensity and an edge. The method also includes capturing with a digital camera a defocused two-dimensional digital inspection image of the illumination region through the glass sheet over an inspection region of the glass sheet. The digital camera has an acceptance circle at the reflective diffuser. The acceptance circle has a position such that it at least partially overlaps the illumination region at the edge. The two-dimensional digital inspection image has a background intensity distribution in the absence of a surface discontinuity defect. The presence of surface continuity defect within the inspection region causes a shift in the position of the acceptance circle relative to the illumination region, which causes a change in the background intensity distribution of the two-dimensional digital inspection image. This change occurs faster than if the illumination region had a substantially constant intensity.

Another aspect of the disclosure is the method as described above, including forming the illumination region to have an intensity that is darkest at the edge.

Another aspect of the disclosure is the method as described above, wherein the digital camera has a two-dimensional image sensor comprising pixels, and further including normalizing with the background intensity distribution and on a per pixel basis the two-dimensional inspection image that has a change in the intensity distribution.

Another aspect of the disclosure is the method described above, wherein the change in the intensity distribution occurs in a localized region of the two-dimensional digital inspection image, and further comprising performing the normalization as a three-slope process that maintains a highest rate of change of pixel intensity for the localized region.

Another aspect of the disclosure is the method as described above, further comprising characterizing the surface discontinuity defect based on the two-dimensional digital inspection image.

Another aspect of the disclosure is a method of optimizing the detection of a surface discontinuity in a glass sheet having front and back surfaces. The method includes arranging a digital camera adjacent the front surface of the glass sheet. The digital camera has a two-dimensional image sensor and a field of view. The method also includes disposing a plurality of calibration surface discontinuities on the glass sheet. The method also includes illuminating a reflective diffuser arranged adjacent and spaced apart from the back side of the glass sheet with gradient illumination that passes through the glass sheet, wherein the camera has an acceptance circle at the reflective diffuser. The method further includes capturing a calibration digital inspection image of the glass sheet and the plurality of calibration surface discontinuities thereon. The method additional includes extracting from the calibration digital inspection image a first intensity distribution of the image of the plurality of calibration surface discontinuities and a second intensity distribution of the gradient illumination, and calculating a derivative of the intensity distribution of the image of the plurality of calibration surface discontinuities. The method also includes adjusting the gradient illumination so that the first and second intensity distributions cross substantially at a location of respective maxima of the calculated derivatives.

Another aspect of the disclosure is the method as described above, wherein the calibration surface discontinuities comprise lens elements.

Another aspect of the disclosure is the method as described above, wherein the calibration surface discontinuities substantially fill the field of view.

Another aspect of the disclosure is an optical inspection system for optically inspecting a glass sheet for a surface discontinuity, the glass sheet having front and back surfaces. The system includes a digital camera arranged adjacent the front surface of the glass sheet and along a system axis. The digital camera has a two-dimensional image sensor that captures a digital inspection image of an inspection region of the glass sheet. The system also has a reflective diffuser arranged along the system axis adjacent and spaced apart from the back side of the glass sheet, and whereat the digital camera has an acceptance circle. The system further includes a coaxial illumination source arranged to provide coaxial illumination along the system axis, wherein the coaxial illumination is focused adjacent the front surface of the glass sheet on the side of the digital camera. A first amount of the coaxial illumination reflects from the front and back surfaces of the glass sheet and contributes to the formation of the digital inspection image. A second amount of the coaxial illumination reflects from the reflective diffuser as diffused reflected light and contributes to the formation of the digital image. The first amount of reflected coaxial illumination is at least two times the second amount of diffused reflected light.

Another aspect of the disclosure is the system as described above, wherein the first amount is between two times and five times the second amount.

Another aspect of the disclosure is the system as described above, wherein the coaxial illumination has a focus distance from the glass sheet front surface in the range from 4 mm to 6 mm.

Another aspect of the disclosure is a method of optically detecting a surface continuity defect in a glass sheet having front and back surfaces. The method includes axially illuminating the glass sheet with light having a focus at a focus distance from the front surface of the glass sheet to form a diverging light beam. The method also includes reflecting a first amount of light from the diverging light beam from the front and back surfaces and forming a two-dimensional digital inspection image from the first amount of light. The method additionally includes diffusedly reflecting a second amount of light from the diverging light beam from a reflective diffuser arranged adjacent the back surface of the glass sheet and including the second amount of light in the two-dimensional digital inspection image, with the first amount being least twice the second amount.

Another aspect of the disclosure is the method as described above, wherein the first amount of light is between two times and five times the second amount of light.

Another aspect of the disclosure is the method as described above, wherein the coaxial illumination has a focus distance from the glass sheet front surface in the range from 4 mm to 6 mm.

Another aspect of the disclosure is the method as described above, further comprising characterizing the surface discontinuity defect based on the two-dimensional digital inspection image.

Additional features and advantages are set forth in the Detailed Description that follows and in part will be readily apparent to those skilled in the art from the description or recognized by practicing the embodiments as described in the written description and claims thereof, as well as the appended drawings. It is to be understood that both the foregoing general description and the following Detailed Description are merely exemplary and are intended to provide an overview or framework for understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 and FIG. 2 are schematic diagrams of an example optical inspection station that includes an optical inspection system operably disposed relative to a glass sheet to be inspected for surface discontinuity defects;

FIG. 3 is a schematic side view of the optical inspection system and glass sheet being inspected, illustrating the field of view of the optical inspection system and a surface discontinuity defect located in the region of the glass sheet being inspected;

FIG. 4 is a front-on view of the glass sheet showing the field of view and the region of the glass sheet being inspected, with an example surface discontinuity defect in the inspection region;

FIG. 5A shows an example of gradient illumination region formed at the reflective diffuser by gradient illumination from a gradient illumination light source;

FIG. 5B is a plot of the intensity I (arbitrary units) versus position in the −Y direction (arbitrary units), showing an example intensity distribution of the gradient illumination region of FIG. 5A;

FIGS. 6A through 6C are schematic diagrams of a prior art illumination configuration wherein constant-intensity illumination is employed, and show the acceptance circle of the digital camera and the constant-intensity illumination as formed on the reflective diffuser;

FIG. 6D shows an example close-up view of a portion of a digital inspection image obtained using an optical inspection system that employed a constant-intensity illumination, and showing an example defect image;

FIGS. 7A through 7C are similar to FIGS. 6A through 6C, except that gradient illumination is employed;

FIG. 7D is similar to FIG. 6D, except that the digital inspection image includes greater variation in intensity around the defect image;

FIG. 8A is similar to FIG. 5A and shows an example of a gradient illumination region wherein a portion (sub-region) thereof has a constant intensity;

FIG. 8B is a plot similar to FIG. 5B and shows the intensity distribution of the example gradient illumination region of FIG. 8A;

FIG. 9 is similar to FIG. 1 and shows an example optical inspection station wherein the transparent glass sheet includes calibration surface discontinuity defects in the form of small lenses used for calibration and set up;

FIG. 10 is an example of a section of a calibration digital inspection image that shows three small lenses used as the calibration surface discontinuities;

FIG. 11 is an idealized intensity I(x) versus position x plot that show an exemplary source discontinuity intensity curve (solid line), a gradient background intensity curve (dotted line) and a derivative curve (dashed line) of the source discontinuity intensity curve, illustrating an example of how these curves align when the system is optimally configured for detecting surface discontinuity defects;

FIGS. 12A through 12C are plots similar to that of FIG. 11 for three different overall intensity values; and

12D through 12F are similar to FIGS. 12A through 12C and illustrate examples of non-optimized gradient illumination;

FIG. 13 plots the output intensity I_{OUT} (in digital number, DN) versus the raw image intensity I_{RAW} (in DN) for an example response wherein the target flat-field intensity is 128DN and the reference image intensity is 170DN; and

FIG. 14 is a schematic diagram of the optical inspection station similar to that shown in FIG. 1, but showing an example embodiment that employs axial illumination in the presence of the reflective diffuser, which is used for gradient illumination.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute a part of this Detailed Description.

The entire disclosure of any publication or patent document mentioned herein is incorporated by reference.

Cartesian coordinates are shown in some of the Figures for the sake of reference and are not intended to be limiting as to direction or orientation.

### Optical Inspection Station and System

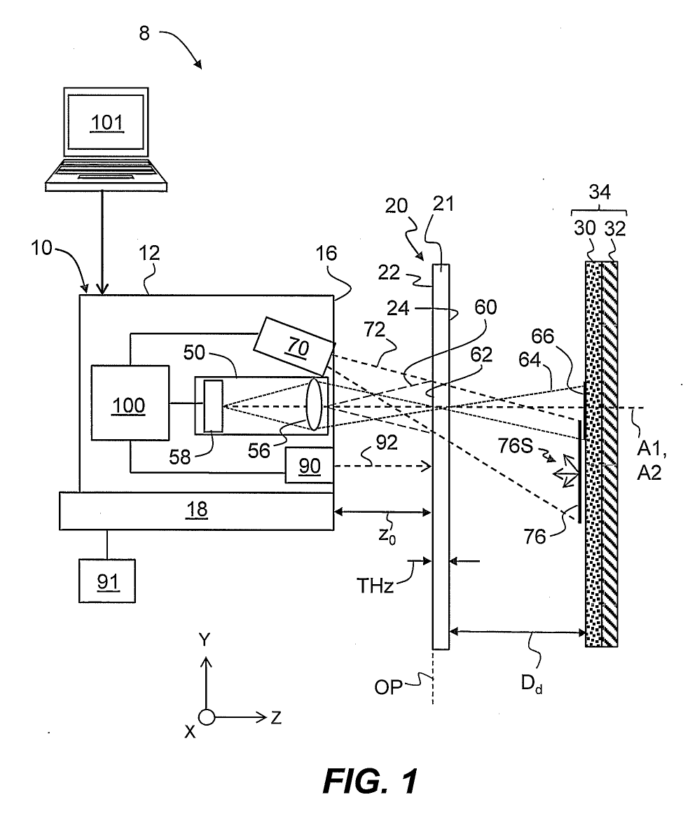

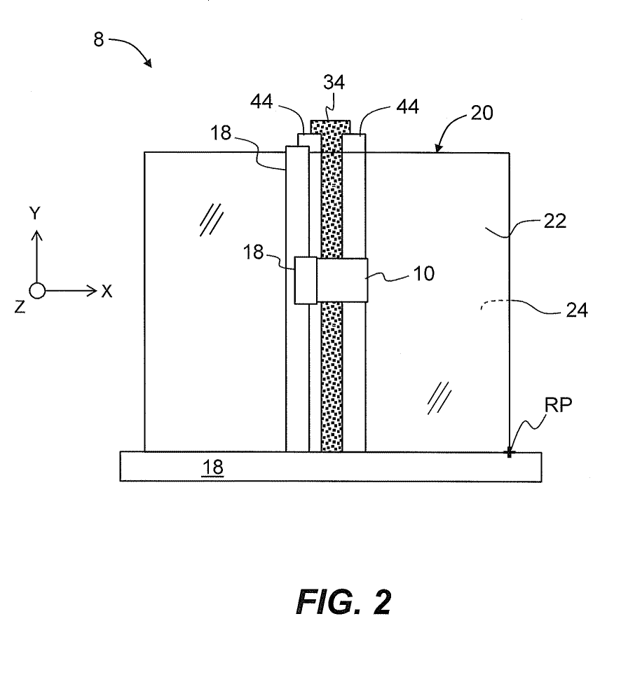

FIG. 1 and FIG. 2 are schematic diagrams of an example optical inspection station 8 that includes an optical inspection system (“system”) 10 operably disposed relative to a glass sheet 20 to be inspected for defects. The optical inspection system 10 includes a housing 12 supported on a movable stage 18 that can move in three dimensions, as indicated by the reference Cartesian coordinates. The housing 12 has a front end 16.

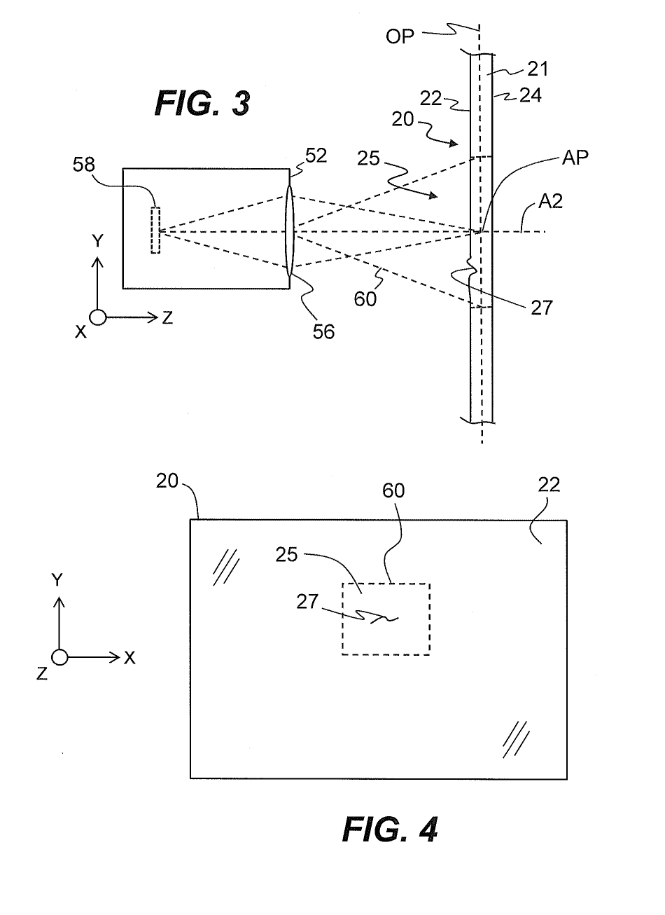

FIG. 3 is a schematic side view of optical inspection system 10 and glass sheet 20 that is being inspected, illustrating a field of view 60 of the optical inspection system. The glass sheet 20 has a body 21 of axial thickness THz and that defines a front surface 22 and a back surface 24. FIG. 4 is a front-on view of glass sheet 20 showing the field of view 60 and inspection region 25 of the glass sheet. The inspection region 25 is defined by the field of view 60 in the X-Y plane as front surface 22. FIG. 4 shows an example of a surface discontinuity (SD) defect 27 located on front surface 22 in inspection region 25.

With reference to FIGS. 1 through 4, glass sheet 20 is operably supported adjacent front end 16 of optical inspection system 10 and along a system axis A1 in an X-Y plane by a support device 44. The thickness THz of glass sheet body 21 is substantially constant and in an example ranges from a few millimeters to less than 0.1 mm. In an example, system axis A1 makes a right angle with front surface 22 of glass sheet 20. In an example, support device 44 holds glass sheet 20 at back surface 24 by constraining the glass sheet with a vacuum and floating the glass sheet on an air cushion (not shown).

A diffuser 30 and a mirror 32 are also arranged along axis A1 and in the X-Y plane, with the diffuser residing adjacent the mirror and between the mirror and back surface 24 of glass sheet 20. The diffuser 30 is placed against mirror 32. The combination of diffuser 30 and mirror 32 define a reflective diffuser 34. Reflective diffuser 34 is spaced apart from back surface 24 of glass sheet 20 by a distance D_{d}, which in an example is in the range from about 80 mm to about 100 mm, e.g., about 90 mm. In an example, reflective diffuser 34 is used to define a virtual light source by shining light onto it.

In an example embodiment, diffuser 30 has a controllable diffusion angle. An example diffuser 30 is the Light Shaping Diffuser® controllable diffuser, available from Luminit, LLC, Torrance, Calif. The control of the diffusion angle of diffuser 30 enables the light reflected from the diffuser to be selectively directed at the angles needed for optimal detection of SD defect 27. A controllable diffusion angle also allows for the reflective diffuser to serve as a tunable virtual light source for illuminating glass sheet 20.

With reference in particular to FIG. 1, optical inspection system 10 includes a digital camera (“camera”) 50 that has a front end 52 and a camera axis A2 that lies along (i.e., is coaxial with) system axis A1. The digital camera 50 includes an imaging lens 56 that may include one or more lens elements or optical elements. The digital camera 50 also includes a two-dimensional (i.e., area array) image sensor 58, such as a CMOS sensor or CCD array that digitizes the image formed by imaging lens 56 to form a two-dimensional digital image. An example resolution of image sensor 58 is in the range from 5 megapixels to 8 megapixels.

Digital camera 50 captures two-dimensional digital images that serve as inspection images, i.e., they can be reviewed (e.g., displayed for a user to see or for a computer to process) to characterize any SD defects 27 that appear in one or more of the inspection images. These two-dimensional digital images are referred to hereinafter as “digital inspection images.”

With reference to FIG. 1, digital camera 50 defines the aforementioned field of view 60. Field of view 60 in turn defines an inspection region 25 on glass sheet 20. In an example, field of view 60 defines the aforementioned inspection region 25. In an example, inspection region 25 has dimensions of about 3,296 mm×2,472 mm, so that in an example one pixel of image sensor 58 represents about 1 μm of glass sheet 20 in inspection region 25.

Digital camera 50 also has an acceptance cone 64 that defines an acceptance circle 66 at reflective diffuser 34. In an example, acceptance circle 66 has a diameter of about 20 mm to 30 mm, e.g., about 24.5 mm. In an example, digital camera 50 has a clear aperture of about 15 mm. It is noted here that acceptance circle 66 is for an on-axis point of image sensor 58, and that every point on the image sensor has an associated acceptance circle. For ease of illustration and discussion, only the on-axis acceptance circle 66 is shown and discussed.

An example image capture rate for digital camera 50 is in the range from about 8 frames per second (fps) to 17 fps (125 milliseconds (ms) to 58 ms), with an exposure time St ranging from 8 ms to 22 ms. In a typical vision system, the time from the exposure to the time the image being available in memory represents a time delay on the order of hundreds of milliseconds, which is much slower than the frame rate. However, digital camera 50 of optical inspection system 10 is ready for the next exposure at a ready-to-acquire time that is essentially the same as the frame rate. This allows the motion subsystems (not shown) associated with movable stage 18 to engage immediately at the conclusion of an exposure to prepare for the next exposure.

An example digital camera 50 has a data transfer rate via an Ethernet Cat 6 cable of 240 MB/s. The digital camera 50 is configured to image over a range of wavelengths, e.g., over wavelengths or bands in the visible spectral range. In an example, digital camera 50 has a depth of field in the range from about 25 microns to about 100 microns. The SD defect 27 is shown within inspection region 25 and on front surface 22 of glass sheet 20.

The optical inspection system 10 also includes a gradient illumination source 70 that emits light 72. Light 72 has a wavelength λ_{G}, which can be any wavelength, mix of wavelengths or white light. In an example, wavelength λ_{G} includes red light, e.g., light in the wavelength range between 600 nm and 650 nm. Gradient illumination source 70 is configured such that light 72 defines a gradient illumination region 76 on reflective diffuser 34. Gradient illumination region 76 is offset from axes A1 and A2 and is thus offset from acceptance circle 66 of digital camera 50. Gradient illumination region 76 and reflective diffuser 34 serve to generate scattered light 76S that back-illuminates glass sheet 20. Gradient illumination region 76 and acceptance circle 66 at least partially overlap at reflective diffuser 34, as described in greater detail below.

With reference again to FIG. 1, optical inspection system 10 also includes an alignment light source 90 that emits alignment light 92. In an example, alignment light source 90 includes a laser. The alignment light source 90 is configured such that alignment light 92 provides an alignment reference for digital camera 50 so that the position of glass sheet 20 and the position of reflective diffuser 34 relative to a reference position RP (see FIG. 2) can be ascertained. In an example, reference position RP has (x, y, z) coordinates (x_{R}, y_{R}, z_{R}), where x_{R}, y_{R}, z_{R} are three spatial reference coordinates. In an example, (x_{R}, y_{R}, z_{R})=(0, 0, 0).

The image sensor 58, gradient illumination source 70 and alignment light source 90 are electrically connected to a controller 100 configured to control the operation of these components in order to carry out the inspection methods as described below. Optical inspection station 8 includes a number of other components that are not all shown for ease of illustration. These components include for example a camera power supply, an illuminator source power supply, and a microcontroller power supply, all of which are operably connected to optical inspection system 10.

In an example, some or all of components of optical inspection station 8 are arranged in a storage unit (e.g., rack, cabinet, etc.) (not shown). Optical inspection station 8 includes an external controller 101 that may be connected to an external device (not shown), such as a computer, server or database, that provides initial inspection information to the external controller. In an example embodiment, this information is used to control the optical inspection of glass sheet 20 as carried out by optical inspection system 10 and in particular identifies inspection region 25.

The optical inspection station 8 also includes a stage driver 91 operably connected to movable stage 18 and is configured to cause the movable stage to move in very precise increments. FIG. 1 shows movable stage 18 located a reference distance z₀ away from front surface 22 of glass sheet 20. In an example, the reference distance z₀ is about 50 mm to 60 mm, e.g., about 55 mm. In an example, stage driver 91 includes a motor encoder and a motor to provide a precise measurement and control of the Z-position of movable stage 18 (and thus optical inspection system 10) relative to reference position RP.

### Detecting SD Defects

In FIG. 1, gradient illumination region 76 is shown as being slightly displaced relative acceptance circle 66 so that their partial overlap can be more clearly seen. The digital inspection image generated when there is no SD defect 27 is a defocused image of the gradient illumination region 76, and thus has a generally graded intensity distribution over the image plane. The SD defect 27 is detected by a change in the intensity distribution of the digital inspection image generated by image sensor 58. The change in the intensity distribution of the digital inspection image can be at least one of a change in position and a change in intensity level. An aspect of the disclosure includes characterizing the SD defect 27 by examining the digital inspection image. This characterization can be done visually or with the assistance of image processing software, e.g., operating in external controller 101 or (internal) controller 100.

As mentioned above, detecting SD defects 27 with digital camera 50 using a two-dimensional image sensor 58 has been problematic to date because it is difficult to get uniform detection across the field of view. The detection of an SD defect 27 relies on the defect changing the angle of the acceptance cone 64 and thus the position of acceptance circle 66 relative to gradient illumination region 76. An area camera is a much wider detector than a slit or linear detector, for which a knife-edge source positioned in the light acceptance cone is critical to the sensitivity in any one part of the detector area. With small shifts in the source position there can be large shifts in the intensity, making it difficult determine the character of the detection.

The position of a single SD defect 27 would need to be shifted across the field of view and observed in order to ascertain the performance of the knife-edge-based detection system. Human visual perception is taxed. The image processing that flattens the field (removes the steep gradient across the field) requires the sample to be removed from the field of view to take a reference image. A new reference image is required with any change in the illumination source position. A laborious process given the shifts in intensity that must be compensated for with each change in the source position and with where across the field the SD sample is placed.

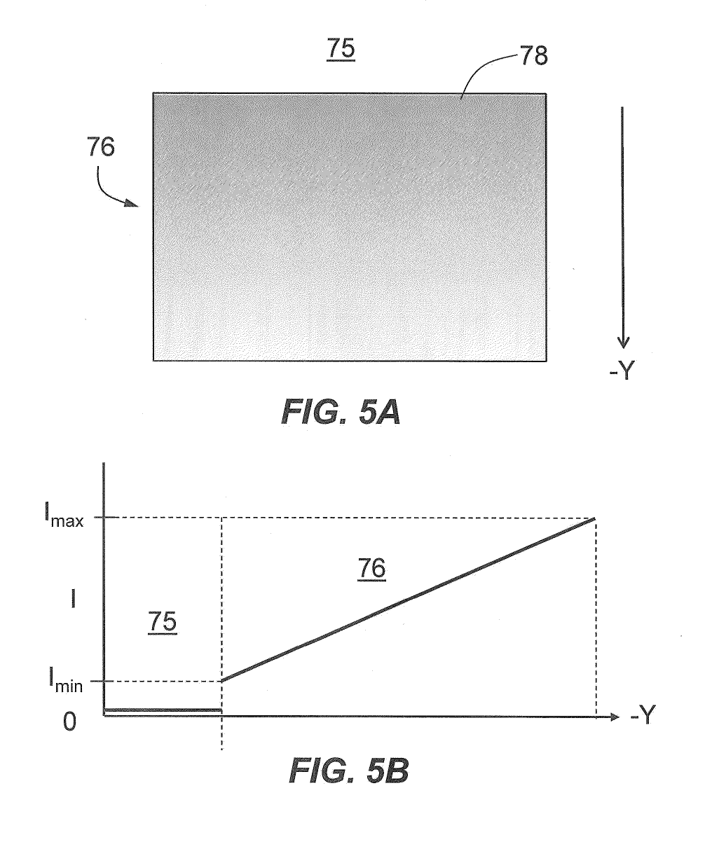

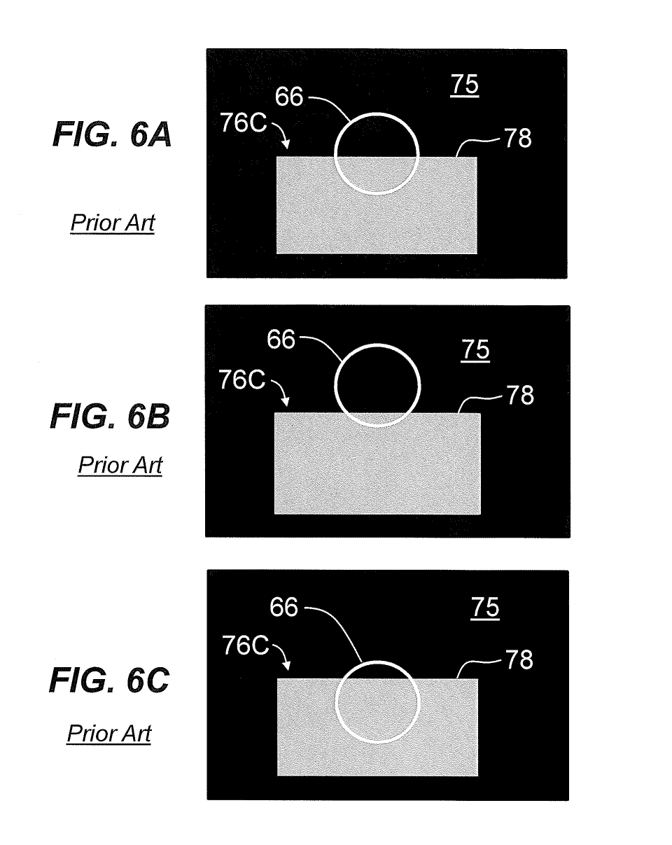

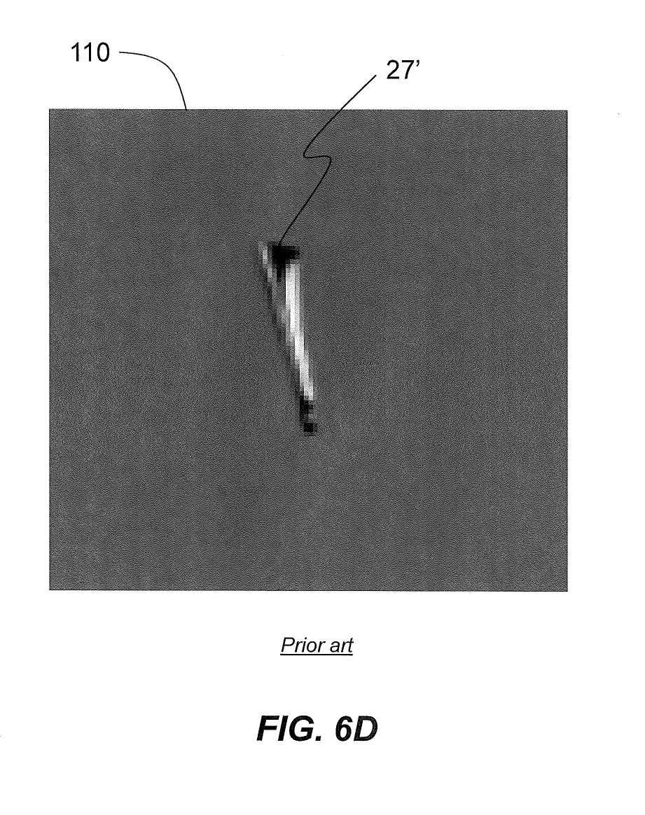

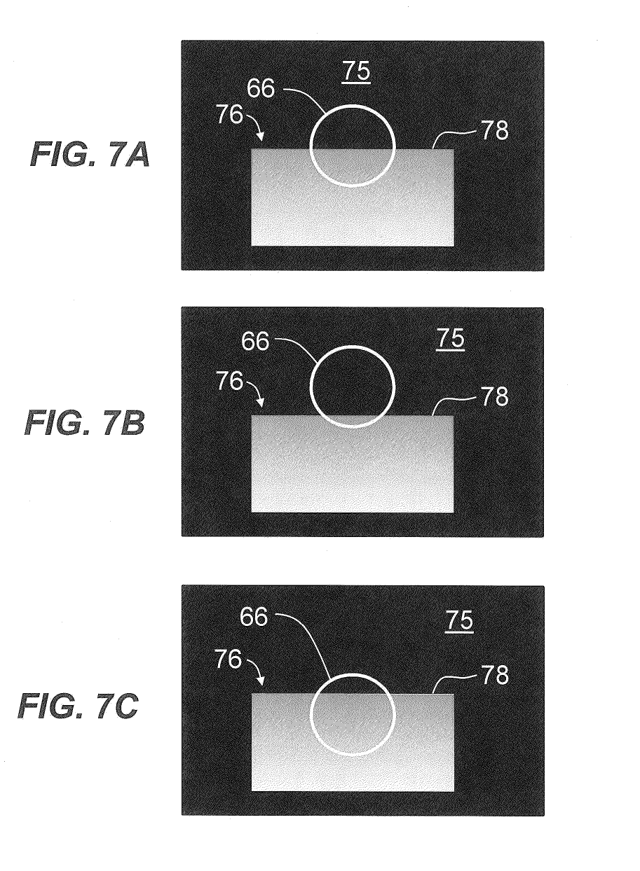

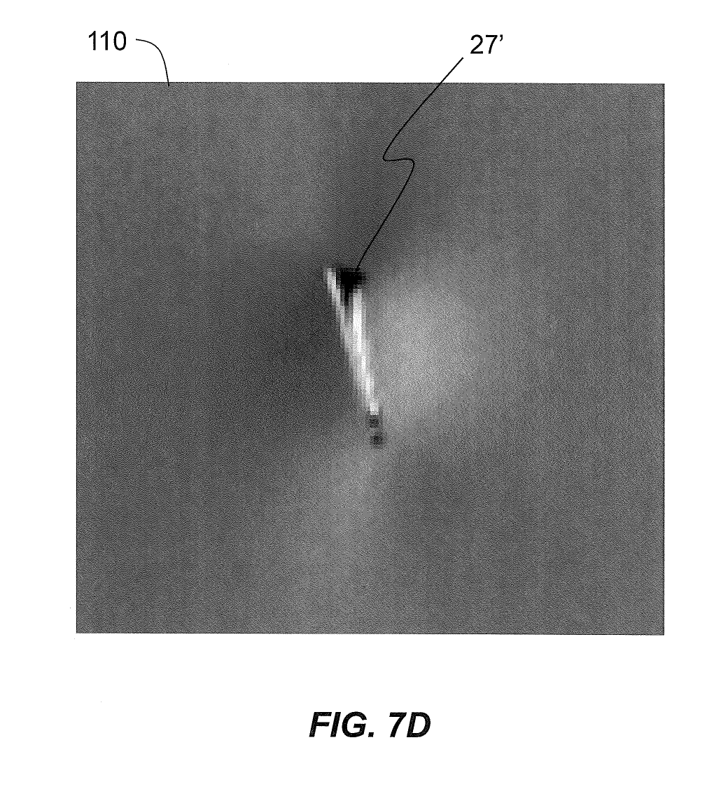

FIG. 5A shows an example of gradient illumination region 76 formed at reflective diffuser 34 by light 72. Gradient illumination region 76 is defined by a gradient in intensity that starts out at a minimum intensity Iₘᵢₙ adjacent to a dark (no-light) region 75 and increases in intensity in the −Y direction to a maximum intensity Iₘₐₓ. Gradient illumination region 76 has an edge 78. In FIGS. 6A-6C and 7A-7C, dark region 75 is shown in black to better visually represent the actual situation.

FIG. 5B is a plot of the intensity I (arbitrary units) versus position in the −Y direction (arbitrary units), showing an example intensity distribution of gradient illumination region 76. The example intensity distribution in FIG. 5B is linear, but the gradient can have other forms beside linear.

FIGS. 6A through 6C are schematic diagrams of a prior art illumination configuration wherein constant-intensity illumination region 76C is employed. The acceptance circle 66 of digital camera 50 and the constant-intensity illumination region as formed on reflective diffuser 34 is shown. FIG. 6A shows the nominal position of acceptance circle 66 relative to constant-intensity illumination region 76C at edge 78, when there is no SD defect 27 present in inspection region 25. In an example, half of acceptance circle 66 resides within constant-intensity illumination region 76C. This position defines a nominal or background or reference intensity distribution at image sensor 58.

FIG. 6B shows a shift in acceptance circle 66 relative to constant-intensity illumination region 76C, wherein the acceptance circle moves away from the constant-intensity illumination region due to the presence of SD defect 27 in inspection region 25. FIG. 6C shows a shift in acceptance circle 66 relative to constant-intensity illumination region 76C at edge 78, wherein the acceptance circle moves into the constant-intensity illumination region due to the presence of SD defect 27 in inspection region 25. The shift in acceptance circle 66 is due to SD defect 27 deflecting the acceptance cone 64.

FIG. 6D shows an example close-up view of a portion of a digital inspection image 110 obtained using an optical inspection system 10 that employed the constant-intensity illumination shown in FIGS. 6A through 6C. An image 27′ of SD defect 27 (“defect image”) appears in digital inspection image 110, and the surrounding region of the SD defect has a relatively uniform intensity. This is because as acceptance circle 66 moves relative to the constant-intensity illumination region 76C, the amount of illumination captured by the acceptance circle is limited by the constant illumination intensity. This is because as the acceptance circle 66 moves relative to the constant-intensity illumination region 76C, the amount of area of the circle that leaves the dark region 75 is the same as that entering the constant-illumination region. This results in a relatively slow change in brightness of the defect image as a function of the acceptance circle shift in position relative to edge 78.

FIGS. 7A through 7C are similar to FIGS. 6A through 6C, except that gradient illumination region 76 is used. In this configuration of optical inspection system 10, this shift in acceptance circle 66 relative to edge 78 due to SD defect 27 results in the intensity distribution at image sensor 58 also getting brighter faster when the acceptance circle moves into the gradient illumination region 76. This is because more light is gained than is lost due to the intensity gradient in gradient illumination region 76. The rate of change of intensity in the digital inspection image is thus faster (i.e., gets brighter or darker faster) than if the illumination region had a constant intensity.

FIG. 7D is digital inspection image 110 similar to that of FIG. 6D, but taken with a system using the above-described gradient illumination region 76. As can be seen from FIG. 7D, the region around SD defect image 27′ has more intensity variation than that in FIG. 6D. This intensity variation serves to amplify the detection of SD defect 27. The defect image 27′ of FIG. 7D represents a localized change in intensity in the digital inspection image 110 and is a close-up view of the larger digital inspection image.

For an example imaging lens 56 having a 15 mm diameter (clear aperture), a 55 mm lens to object plane z₀, and an 88 mm object to diffuse light source distance D_{d}, the ratio 88/55=1.6 is defined. Thus, the 15 mm lens diameter maps to an acceptance circle of about 24 mm. A field of view 60 of +/−2 mm maps to a shift of the acceptance circle 66 of about −/−3.2 mm.

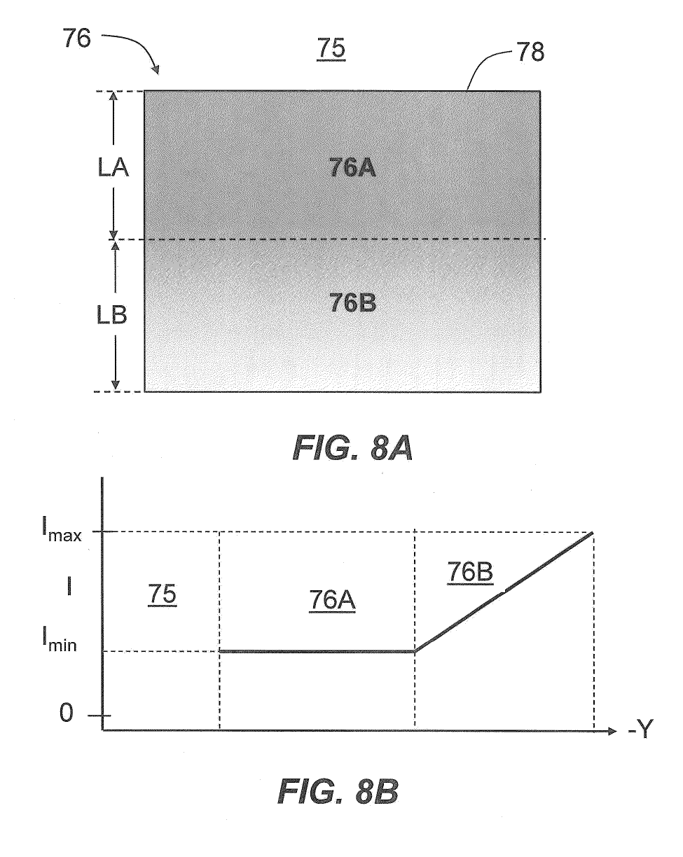

FIG. 8A is similar to FIG. 5A and illustrates an example embodiment of gradient illumination region 76 that includes a constant-intensity sub-region 76A of length LA followed by a steep gradient sub-region 76B of length LB. In an example, length LA of constant intensity sub-region 76A is equal to about the radius of acceptance circle 66 (e.g., LA=12 mm for a 24 mm acceptance circle 66).

### System Set-Up and Calibration

The ability of optical inspection station 8 to detect SD defects 27 can be optimized by proper set up and calibration. This involves measuring the intensity response over the field of view 60 using one or more calibration SDs arranged within the field of view.

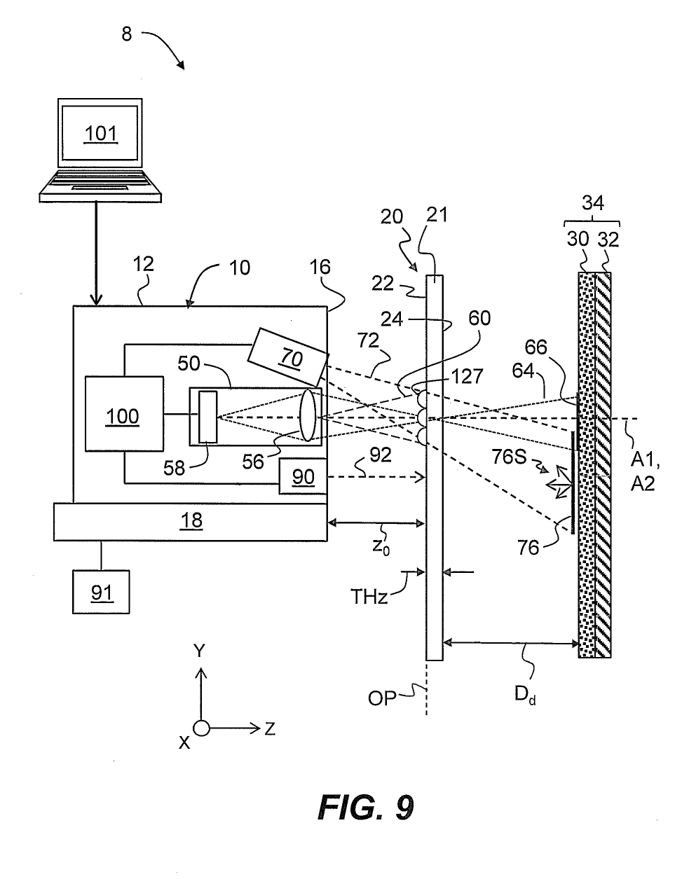

FIG. 9 is similar to FIG. 1 and shows an example embodiment of optical inspection station 8 that includes example calibration SDs 127 arranged on front surface 22 of glass sheet 20. In an example, calibration SDs 127 are lens elements, e.g., plano-convex elements or otherwise lenticular elements with a 1 mm diameter and a 2 mm focal length. Such small lens elements can be bonded to front surface 22 of glass sheet 20 using a UV-cured bonding material. The calibration SDs 127 have a known curvature and thickness and so impact the transmission of light in a known way. In an example, calibration SDs 127 cover substantially the entire field of view 60, e.g., at least 90% of the field of view.

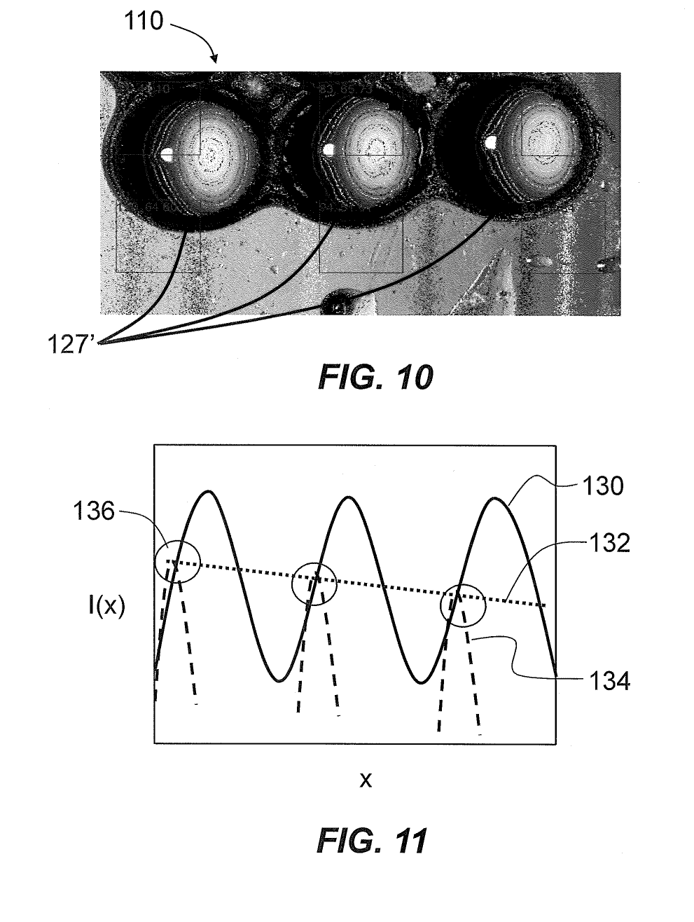

FIG. 10 is an example of a section of a calibration digital inspection image 110 that includes regions 127′ corresponding to the location of calibration SDs 127. The example calibration digital inspection image 110 includes intensity contours, which can be color-coded for viewing ease when displayed.

FIG. 11 is an idealized plot of the intensity versus position for various portions of digital inspection image 110 of FIG. 10. A solid-line curve 130 plots the intensity taken across regions 127′ and is referred to as the SD intensity curve. Also shown in the plot of FIG. 11 is the gradient background (or reference) intensity curve 132 (dotted line) as taken from a cross-section of the digital inspection image 110 outside of regions 127′. In addition, a dashed-line derivative curve 134 of the SD intensity curve 130 is shown. Only the top part of the derivative curve is shown.

Circles 136 in FIG. 11 show where the three different curves 130, 132 and 134 meet. Ideally, the gradient background intensity curve 132 crosses the SD intensity curve 130 at the peak of the derivative curve 134, i.e., within circles 136 as shown, for all field positions. This means that the gradient background intensity corresponds to the maximum rate of change of the SD intensity curve. Said differently, where the SD intensity curve 130 matches the derivative curve 134 is the point where the slope of the curved surface of calibration SD 127 is passing through zero, which is equivalent to no SD being present. This is the “straight through” light that passes through the center of calibration SDs 127.

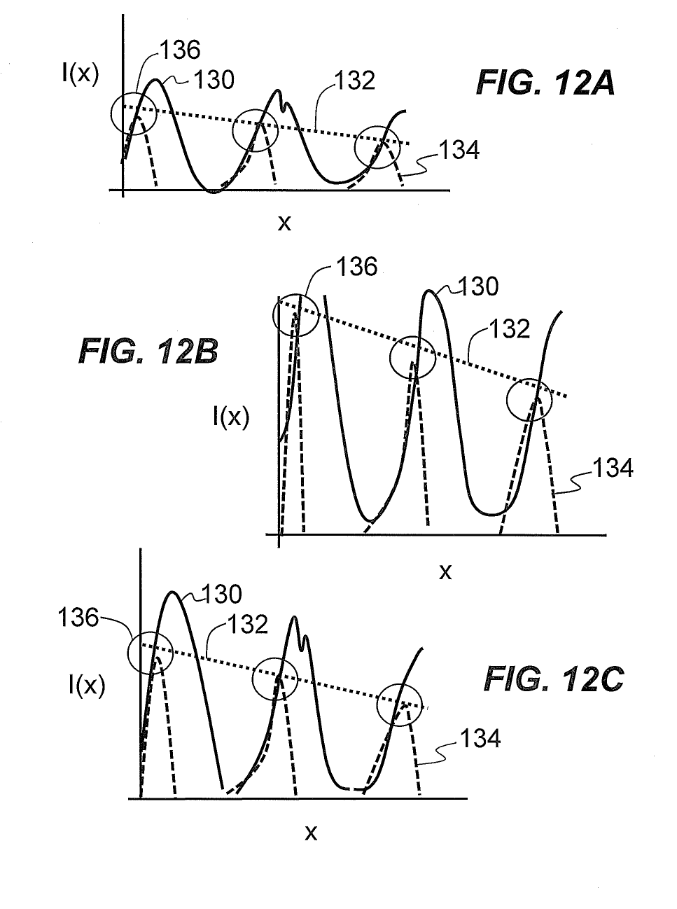

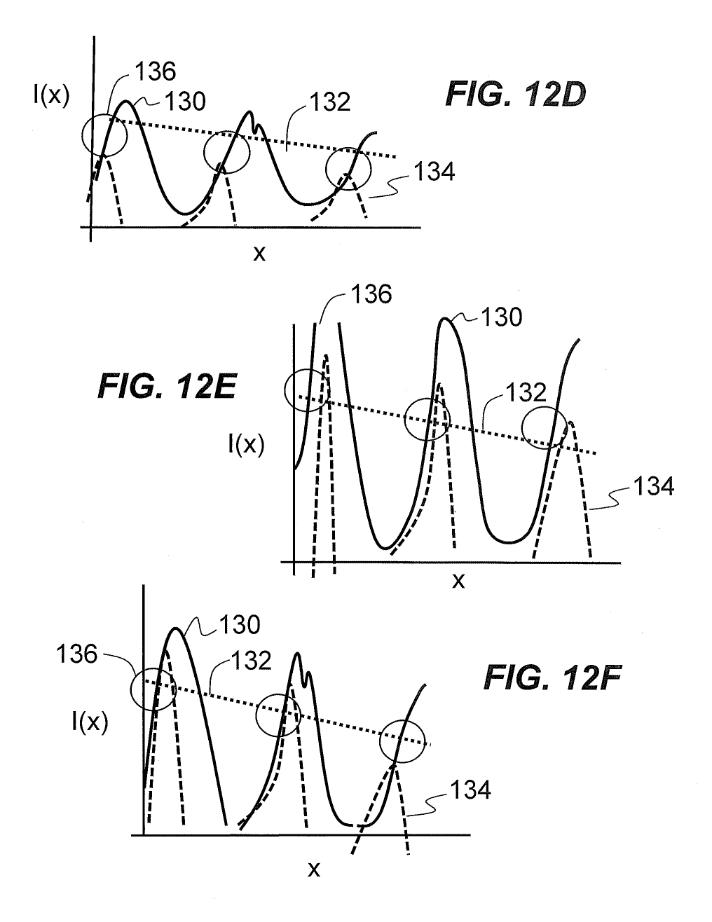

FIGS. 12A through 12C are plots similar to FIG. 11 and schematically illustrate the SD intensity curve 130, the gradient background intensity curve 132 and the derivative curve 134 at three different field locations. The absolute intensity variation does not change the target cross-over locations indicated by circles 136. In this example, the relative positions of the gradient illumination region 76 and acceptance circle 66 of digital camera 50 is good. Deviations from the ideal locations of curves 130, 132 and 134 can be adjusted by adjusting the position of gradient illumination region 76 to match the acceptance circles 66 that correspond to the given field locations.

FIGS. 12E through 12F are similar to FIGS. 12A through 12 and show examples where the peaks of the derivative curve 134 are not aligned with where the gradient background intensity curve 132 crosses the SD intensity curve 130. These cases illustrate poor and inconsistent SD detection across the field.

By using calibration SDs 127 with multiple SD zones across the field of view 60 of digital camera 50, the SD response of optical inspection system 10 can be measured. Proper setup is accomplished by having the peak SD response (i.e., the derivative of the SD intensity) at the point where the gradient background intensity is substantially equal to the SD intensity across the field of view. The analysis of the digital inspection calibration image compares the slope of the intensity change within the calibration SD and the absolute intensity within the calibration SD with the gradient background intensity. As noted above, adjusting the position of the gradient intensity region can bring the system into its optimum SD measurement configuration.

In operation, optical inspection system 10 performs an intensity gain correction related to the gradient background intensity. To improve the visual character of the response, a two-slope flat field correction can be used. One slope passes through the reference white level and some intensity level above to keep the gain constant for enhancing the sensitivity for detecting small SD defects 27. The other slope passes above that level so that saturated pixels keep their “white” character for better visual consistency.

In an example two-slope correction, grey levels from 0DN to 170DN are multiplied by about 0.75 to map them to 0DN to 128DN, so the 170DN background is flat at the target intensity. Values from 170DN to 255DN are multiplied by (255−128)/(255−170)≈1.5, so that a saturated 255DN in the source image would still reach saturation in the flattened image. In an example where the image is relatively dark (say 64DN) and needs to be increased to the target flat field 128DN, values are be multiplied by 128/64=2. But this means intensity values greater than about 128DN would be fully saturated (255DN) in the resulting output image.

With a two-slope correction, values greater than 64DN can instead be multiplied by (255−128)/(255−64)=0.67 for example, so that detail in the original image represented by intensity levels between 128 and 255 would still have some representation in the output image.

A further improvement can be obtained using a three-slope correction. An example three-slope correction has a central slope (typically 1) to reduce the loss of intensity detail around background intensity (say +/−20 or 30DN). The slope is then adjusted below and above the central region to compress or expand the remaining DN values to map to the full available dynamic range.

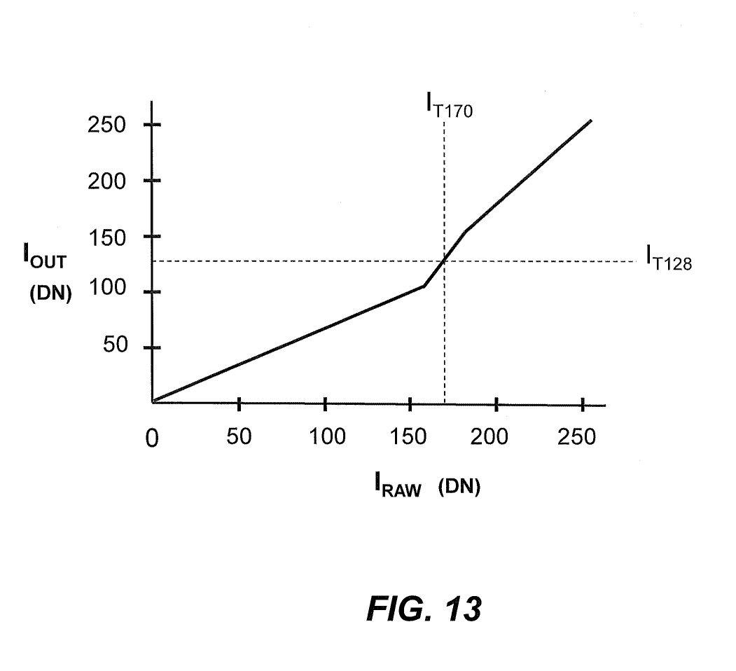

FIG. 13 is a plot that illustrates an example of such three-slope correction. FIG. 13 plots the output intensity I_{OUT} (in digital number, DN) versus the raw image intensity I_{RAW} (in DN) for an extreme example response wherein the target flat-field intensity I_{T} is 128DN and the reference (background) image intensity I_{R} is 170DN. The DN Range is 0 to 255, with 255 representing saturation. The region of steepest slope corresponds to the location of defect image 27′ within the larger digital inspection image 110.

When the digital inspection image is already bright due to the gradient background (e.g., 170DN versus 128DN), the gain correction reduces the intensity in the bright area by multiplying by 128/170 (about 0.75). However, a saturated signal of 255DN would be reduced to 192DN and thus not appear to be saturated.

In performing field flattening (i.e., removing the intensity gradient in the digital inspection image), a reference image is taken with no sample in the image. Any change in the background, as happens when adjusting the gradient illumination, requires taking a new reference image. By using the technique of maximum derivative of SD intensity where the SD intensity is substantially the same as background intensity, the absolute intensity need only be within the dynamic range of image sensor 58. This obviates the need to collect reference images with each lighting change while setting up optical inspection system 10.

### On-Axis Illumination

In some cases, on-axis illumination may be desirable for optically inspecting glass sheet 20 for SD defect 27. However, in the situation where optical inspection station 8 is set up for off-axis gradient illumination, on-axis light that reflects from reflective diffuser 34 (FIG. 1) can serve as a virtual light source that can interfere with the on-axis measurement.

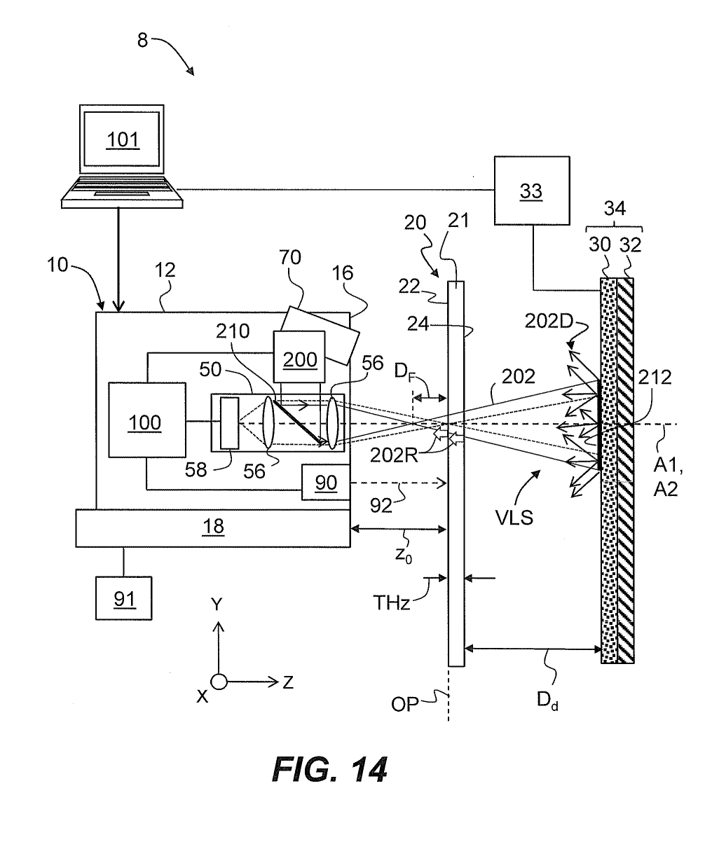

FIG. 14 is a schematic diagram of an example embodiment of optical inspection station 8 and optical inspection system 10 similar to that of FIG. 1, except that it further includes an on-axis illumination source 200 that emits light 202. Thus, optical inspection system 10 of FIG. 14 can perform both on-axis and off-axis gradient inspections of glass sheet 20.

Digital camera 50 includes a beam splitter 210 arranged along system axis A1 so that light 202 from on-axis illumination source 200 is reflected along system axis A1 and then focused by imaging lens 56 to a focus position 204 that is between housing front end 16 and the front surface 22 of glass sheet 20. In an example, focus position 204 is at a focus distance D_{E} from front surface 22 of glass sheet 20 (towards digital camera 50). In an example, focus distance D_{E} is in the range from 4 mm to 6 mm. The focused light 202 diverges from focus position 204 and illuminates front surface 22 and back surface 24 of glass sheet 20. A first amount of focused light 202 is reflected from these surfaces as diverging light and forms reflected light 202R, which returns to digital camera 50 and is analyzed for defects. Thus, the first amount of focused light contributes to the on-axis digital inspection image.

The undeflected and diverging portion of focused light 202 illuminates on-axis portion 212 of reflective diffuser 34. Reflective diffuser 34 then reflects and diffuses light 202 to form diffused reflected light 202D that has substantially reduced intensity. Diffused reflected light 202D illuminates glass sheet 20 from behind as a virtual light source VLS. Digital camera 50 thus receives a second amount of light in the form of diffused reflected light 202D, which passes through glass sheet 20. Digital camera 50 forms an out-of-focus digital inspection image from diffused reflected light 202D. While this second amount of diffused reflected light 202D contributes to the on-axis digital inspection image, it does not substantially reduce the contrast of the portion of the digital inspection images corresponding to the front surface 22 and back surface 24 of glass sheet 20. Consequently, reflected light 202R from glass sheet 20 can be analyzed for defects. In an example, the first amount of reflected light 202R received by digital camera 50 is at least twice the amount of diffuse reflected light 202D, while in another example it is between two and five times the amount of diffuse reflected light.

As noted above, on-axis light 202 is focused to a focus position 204 located at a focus distance D_{E} from glass sheet 20. Thus, when the circle of light 202 is first incident upon glass sheet 20, it is still fairly concentrated, so that the light can be used efficiently, i.e., it reflects relatively strongly from front surface 22 and back surface 24 of glass sheet 20. Also, diffused reflected light 202D is out of focus while SD defect 27 is in focus. Thus, any features that might be present in reflective diffuser 34 are washed out and do not substantially degrade the on-axis digital inspection image. The expanding on-axis beam of light 202 allows for flexibility in positioning of reflective diffuser 34.

In an example embodiment, diffuser 30 of reflective diffuser 34 has an adjustable degree of directionality of the diffused reflected light 202. In an example, diffuser 30 can be configured via a diffuser controller 33 operably connected to diffuser 30 and external controller 101 to provide a range of directionality, from Lambertian (“cos θ”) to highly directional (e.g., cos^{N}θ, where N=2, 3, . . . etc.). Reflective diffuser 34 can also be angled relative to system axis A1 (i.e., other than the right angle, as shown in FIG. 9).

The configuration of optical inspection station 8 of FIG. 14 allows for an axial illumination inspection of SD defect 27 to be made in the presence of reflective diffuser 34, which is used for off-axis gradient illumination inspection as described above. This avoids having to reconfigure optical inspection station 8 to mitigate or eliminate any adverse effects reflective diffuser 34 would have for the axial illumination inspection.

it will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. An optical inspection system for detecting a surface discontinuity defect in a glass sheet having front and back surfaces, comprising:
a digital camera arranged adjacent the front surface of the glass sheet and along a system axis, the digital camera having a two-dimensional image sensor that captures a digital inspection image of an inspection region of the glass sheet;
a reflective diffuser arranged along the system axis adjacent and spaced apart from the back surface of the glass sheet, wherein the digital camera has an acceptance circle at the reflective diffuser; and
a gradient illumination source arranged to provide gradient illumination light through the glass sheet from the front surface to form a gradient illumination region on the reflective diffuser, wherein the acceptance circle of the digital camera partially overlaps the gradient illumination region and can shift relative to the gradient illumination region due to the presence of the surface discontinuity defect within the inspection region.

2. The optical inspection system according to claim 1, wherein the partial overlap of the acceptance circle and the gradient illumination region occurs at an edge of the gradient illumination region, and wherein the gradient illumination region is darkest at an edge thereof.

3. The optical inspection system according to claim 2, wherein the gradient illumination region has a sub-region having a constant intensity that resides adjacent the edge.

4. The optical inspection system according to claim 3, wherein the constant-intensity sub-region and the acceptance circle have substantially the same dimension in the direction of the shift in the acceptance circle.

5. The optical inspection system according to claim 1, wherein the gradient illumination region has a linear intensity variation in a direction of the shift in the acceptance circle.

6. A method of optically inspecting a glass sheet having front and back surfaces for a surface discontinuity defect, comprising:
illuminating a reflective diffuser arranged adjacent to and spaced apart from the back surface of the glass sheet, wherein light from said illuminating travels through the glass sheet and forms an illumination region on the reflective diffuser, wherein the illumination region has a gradient intensity and an edge;
capturing with a digital camera a defocused two-dimensional digital inspection image of the illumination region through the glass sheet over an inspection region of the glass sheet, wherein the digital camera has an acceptance circle at the reflective diffuser having a position that at least partially overlaps the illumination region at the edge; and
wherein the two-dimensional digital inspection image has a background intensity distribution in the absence of a surface discontinuity defect, and wherein the presence of surface continuity defects within the inspection region causes a shift in the position of the acceptance circle relative to the illumination region, thereby causing a change in the background intensity distribution of the two-dimensional digital inspection image that occurs faster than if the illumination region had a substantially constant intensity.

7. The method according to claim 6, including forming the illumination region to have an intensity that is darkest at the edge.

8. The method according to claim 6, wherein the digital camera has a two-dimensional image sensor comprising pixels, and further including normalizing with the background intensity distribution, and on a per pixel basis, the two-dimensional inspection image that has a change in the intensity distribution.

9. The method according to claim 6, wherein the change in the background intensity distribution occurs in a localized region of the two-dimensional digital inspection image, and further comprising performing the normalization as a three-slope process that maintains a highest rate of change of pixel intensity for the localized region.

10. The method according to claim 6, further comprising characterizing the surface discontinuity defect based on the two-dimensional digital inspection image.

11. A method of optimizing detection of a surface discontinuity in a glass sheet having front and back surfaces, comprising:
arranging a digital camera adjacent the front surface of the glass sheet, the digital camera having a two-dimensional image sensor and a field of view;
disposing a plurality of calibration surface discontinuities on the glass sheet;
illuminating a reflective diffuser arranged adjacent to and spaced apart from the back surface of the glass sheet with gradient illumination that passes through the glass sheet, wherein the camera has an acceptance circle at the reflective diffuser;
capturing a calibration digital inspection image of the glass sheet and the plurality of calibration surface discontinuities thereon;
extracting from the calibration digital inspection image a first intensity distribution of the image of the plurality of calibration surface discontinuities and a second intensity distribution of the gradient illumination, and calculating a derivative of the intensity distribution of the image of the plurality of calibration surface discontinuities; and
adjusting the gradient illumination so that the first and second intensity distributions cross substantially at a location of respective maxima of the calculated derivatives.

12. The method according to claim 11, wherein the calibration surface discontinuities comprise lens elements.

13. The method according to claim 11, wherein the calibration surface discontinuities substantially fill the field of view.

14. An optical inspection system for optically inspecting a glass sheet for a surface discontinuity, the glass sheet having front and back surfaces, the system comprising:
a digital camera arranged adjacent the front surface of the glass sheet and along a system axis, the digital camera having a two-dimensional image sensor that captures a digital inspection image of an inspection region of the glass sheet;
a reflective diffuser arranged along the system axis adjacent to and spaced apart from the back surface of the glass sheet, and whereat the digital camera has an acceptance circle;
a coaxial illumination source arranged to provide coaxial illumination along the system axis, wherein the coaxial illumination is focused adjacent the front surface of the glass sheet;
wherein a first amount of the coaxial illumination reflects from the front and back surfaces of the glass sheet and contributes to the formation of the digital inspection image;
wherein a second amount of the coaxial illumination reflects from the reflective diffuser as diffused reflected light and contributes to the formation of the digital inspection image; and
wherein the first amount of reflected coaxial illumination is at least two times the second amount of diffused reflected light.

15. The optical inspection system of claim 14, wherein the first amount is between two times and five times the second amount.

16. The optical inspection system of claim 14, wherein the coaxial illumination has a focus distance from the glass sheet front surface in a range from 4 mm to 6 mm.

17. A method of optically detecting a surface continuity defect in a glass sheet having front and back surfaces, comprising:
axially illuminating the glass sheet with light having a focus at a focus distance from the front surface of the glass sheet to form a diverging light beam;
reflecting a first amount of light from the diverging light beam from the front and back surfaces and forming a two-dimensional digital inspection image from the first amount of light;
diffusedly reflecting a second amount of light from the diverging light beam from a reflective diffuser arranged adjacent the back surface of the glass sheet and including the second amount of diffused reflected light in the two-dimensional digital inspection image; and
wherein the first amount is at least twice the second amount.

18. The method of claim 17, wherein the first amount is between two times and five times the second amount.

19. The method of claim 17, wherein the coaxial illumination has a focus distance from the glass sheet front surface in the range from 4 mm to 6 mm.

20. The method of claim 17, further comprising characterizing the surface discontinuity defect based on the two-dimensional digital inspection image.
